(19) United States
(12) Patent Application Publication
(10) Pub. No.: US 2021/0112433 A1
(43) Pub. Date: Apr. 15, 2021

(54) LAYER 1 SIGNAL TO INTERFERENCE NOISE RATIO REPORTING CONFIGURATION

(71) Applicant: QUALCOMM Incorporated, San Diego, CA (US)

(72) Inventors: Jung Ho RYU, Fort Lee, NJ (US); Yan ZHOU, San Diego, CA (US); Tao LUO, San Diego, CA (US); Kiran VENUGOPAL, Raritan, NJ (US); Tianyang BAI, Bridgewater, NJ (US); Junyi LI, Chester, NJ (US)

(21) Appl. No.: 16/948,963

(22) Filed: Oct. 7, 2020

Related U.S. Application Data
(60) Provisional application No. 62/914,492, filed on Oct. 13, 2019.

(51) Int. Cl. H04W 24/10; H04B 17/309

(52) U.S. Cl. CPC H04W 24/10; H04B 17/309

(57) ABSTRACT

Various aspects of the present disclosure generally relate to wireless communication. In some aspects, a base station (BS) may determine a configuration for differential layer 1 (L1) signal to interference noise ratio (L1-SINR) reporting; transmit, to a user equipment (UE), an indicator of the configuration for differential L1-SINR reporting; and receive, from the UE, one or more differential L1-SINR reports in accordance with the configuration for differential L1-SINR reporting. Numerous other aspects are provided.

### CROSS-REFERENCE TO RELATED APPLICATION

This Patent Application claims priority to U.S. Provisional Patent Application No. 62/914,492, filed on Oct. 13, 2019, entitled “LAYER 1 SIGNAL TO INTERFERENCE NOISE RATIO REPORTING CONFIGURATION,” and assigned to the assignee hereof. The disclosure of the prior Application is considered part of and is incorporated by reference into this Patent Application.

### INTRODUCTION

Aspects of the present disclosure generally relate to wireless communication and to techniques and apparatuses for measurement reporting configuration.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication performed by a user equipment (UE) includes determining a configuration for differential layer 1 signal to interference noise ratio (L1-SINR) reporting, wherein the differential L1-SINR reporting includes an indicator of a value of an L1-SINR relative to a previously identified value of the L1-SINR. The method includes transmitting one or more differential L1-SINR reports in accordance with the configuration for differential L1-SINR reporting.

In some aspects, a UE for wireless communication includes: a memory; and one or more processors coupled to the memory, the memory and the one or more processors configured to determine a configuration for differential L1-SINR reporting, wherein the differential L1-SINR reporting includes an indicator of a value of an L1-SINR relative to a previously identified value of the L1-SINR. The memory and the one or more processors may be configured to transmit one or more differential L1-SINR reports in accordance with the configuration for differential L1-SINR reporting.

In some aspects, a UE for wireless communication may include memory and one or more processors operatively coupled to the memory. The memory and the one or more processors may be configured to determine a configuration for differential L1-SINR reporting, wherein the differential L1-SINR reporting includes an indicator of a value of an L1-SINR relative to a previously identified value of the L1-SINR, and to transmit one or more differential L1-SINR reports in accordance with the configuration for differential L1-SINR reporting.

In some aspects, an apparatus for wireless communication may include means for determining a configuration for differential layer 1 signal to interference noise ratio (L1-SINR) reporting, wherein the differential L1-SINR reporting includes an indicator of a value of an L1-SINR relative to a previously identified value of the L1-SINR. The apparatus includes means for transmitting one or more differential L1-SINR reports in accordance with the configuration for differential L1-SINR reporting.

In some aspects, a method of wireless communication, performed by a base station (BS), may include determining a configuration for differential layer 1 (L1) signal to interference noise ratio (L1-SINR) reporting. The method may include transmitting, to a user equipment (UE), an indicator of the configuration for differential L1-SINR reporting. The method may include receiving, from the UE, one or more differential L1-SINR reports in accordance with the configuration for differential L1-SINR reporting.

In some aspects, a method of wireless communication, performed by a UE, may include receiving, from a BS, an indicator of a configuration for differential L1-SINR reporting. The method may include determining the configuration for differential L1-SINR reporting based at least in part on receiving the indicator of the configuration for differential L1-SINR reporting. The method may include transmitting, to the BS, one or more differential L1-SINR reports in accordance with the configuration for differential L1-SINR reporting.

In some aspects, a BS for wireless communication may include memory and one or more processors operatively coupled to the memory. The memory and the one or more processors may be configured to determine a configuration for differential L1-SINR reporting. The memory and the one or more processors may be configured to transmit, to a UE, an indicator of the configuration for differential L1-SINR reporting. The memory and the one or more processors may be configured to receive, from the UE, one or more differential L1-SINR reports in accordance with the configuration for differential L1-SINR reporting.

In some aspects, a UE for wireless communication may include memory and one or more processors operatively coupled to the memory. The memory and the one or more processors may be configured to receive, from a BS, an indicator of a configuration for differential L1-SINR reporting. The memory and the one or more processors may be configured to determine the configuration for differential L1-SINR reporting based at least in part on receiving the indicator of the configuration for differential L1-SINR reporting. The memory and the one or more processors may be configured to transmit, to the BS, one or more differential L1-SINR reports in accordance with the configuration for differential L1-SINR reporting.

In some aspects, a non-transitory computer-readable medium may store one or more instructions for wireless communication. The one or more instructions, when executed by one or more processors of a BS, may cause the one or more processors to determine a configuration for differential L1-SINR reporting, transmit, to a UE, an indicator of the configuration for differential L1-SINR reporting, and receive, from the UE, one or more differential L1-SINR reports in accordance with the configuration for differential L1-SINR reporting.

In some aspects, a non-transitory computer-readable medium may store one or more instructions for wireless communication. The one or more instructions, when executed by one or more processors of a UE, may cause the one or more processors to receive, from a BS, an indicator of a configuration for differential L1-SINR reporting, determine the configuration for differential L1-SINR reporting based at least in part on receiving the indicator of the configuration for differential L1-SINR reporting, and transmit, to the BS, one or more differential L1-SINR reports in accordance with the configuration for differential L1-SINR reporting.

In some aspects, an apparatus for wireless communication may include means for determining a configuration for differential L1-SINR reporting. The apparatus may include means for transmitting, to a UE, an indicator of the configuration for differential L1-SINR reporting. The apparatus may include means for receiving, from the UE, one or more differential L1-SINR reports in accordance with the configuration for differential L1-SINR reporting.

In some aspects, an apparatus for wireless communication may include means for receiving, from a BS, an indicator of a configuration for differential L1-SINR reporting. The apparatus may include means for determining the configuration for differential L1-SINR reporting based at least in part on receiving the indicator of the configuration for differential L1-SINR reporting. The apparatus may include means for transmitting, to the BS, one or more differential L1-SINR reports in accordance with the configuration for differential L1-SINR reporting.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIGS. 3A and 3B are diagrams illustrating an example of differential L1-SINR reporting configuration, in accordance with various aspects of the present disclosure.

FIG. 4 is a diagram illustrating an example process performed, for example, by a base station, in accordance with various aspects of the present disclosure.

FIG. 5 is a diagram illustrating an example process performed, for example, by a user equipment, in accordance with various aspects of the present disclosure.

FIG. 6 is a diagram illustrating an example process performed, for example, by a user equipment, in accordance with various aspects of the present disclosure.

FIGS. 7-12 are diagrams illustrating example apparatuses, in accordance with various aspects of the present disclosure.

### DETAILED DESCRIPTION

In some communications systems, a user equipment (UE) may perform a signal to interference noise ratio (SINR) measurement of a beam transmitted by a base station (BS). The UE may report the SINR measurement to the BS to enable the BS to control beam parameters, such as transmission power, beamforming configuration, combinations thereof, and/or the like. Additionally, or alternatively, the BS may use information identifying the SINR measurement to determine whether to transmit using the beam, for scheduling, combinations thereof, and/or the like. To reduce a time between feedback reports, the UE may perform a SINR measurement over a relatively short duration of time and without using a measurement filter. By performing the SINR measurement over a relatively short period of time, the UE does not average interference over more than a small number of beams or a single beam. In this way, the UE captures an instantaneous (e.g., L1) measurement of the SINR (e.g., an L1-SINR measurement).

Reporting each L1-SINR measurement as an absolute value may use a particular quantity of bits. For example, to report a L1-SINR measurement of 10 decibels (dB), the UE may use, for example, 4 bits. Thus, to reduce a utilization of network traffic, the UE may report the L1-SINR measurement as a difference from a previously reported SINR measurement (e.g., a differential L1-SINR measurement). For example, rather than reporting an absolute SINR measurement of 10 dB, the UE may report a differential L1-SINR of +1 dB. In this case, the BS may determine that the L1-SINR is 10 dB based on adding the differential L1-SINR of +1 dB to a previously stored value for the L1-SINR of 9 dB.

Some aspects described herein enable differential L1-SINR reporting configuration. For example, a BS may transmit, to a UE, an indication of a configuration for differential L1-SINR reporting, such as a range of a largest measured value of an L1-SINR, a step size of the range of the largest measured value, a step size with which a differential L1-SINR value is computed in reference to the largest measured value of the L1-SINR, a quantity of bits allocated to a quantization of the differential L1-SINR, a combination thereof, and/or the like. In some aspects, the BS may periodically change the configuration for differential L1-SINR reporting, such as to increase a step size of differential L1-SINR reporting, decrease a step size of differential L1-SINR reporting, change another parameter of differential L1-SINR reporting, and/or the like. In this way, the BS and the UE may control differential L1-SINR reporting configuration, thereby enabling a reduction in network traffic by enabling reporting of differential L1-SINR values and also obtain a threshold level of accuracy of L1-SINR measurement reporting.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

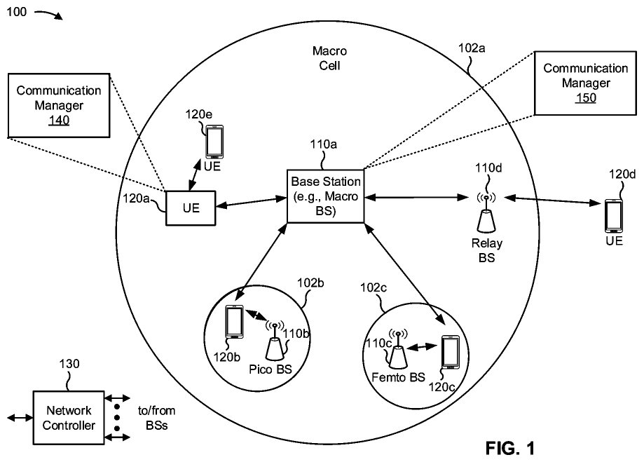

FIG. 1 is a diagram illustrating a wireless network 100 in which aspects of the present disclosure may be practiced. The wireless network 100 may be an LTE network, a 5G or NR network, and/or the like. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

As shown in FIG. 1, the UE 120 may include a communication manager 140. As described in more detail elsewhere herein, the communication manager 140 may receive an indicator of a configuration for differential L1-SINR reporting, determine the configuration for differential L1-SINR reporting based at least in part on the indicator, transmit one or more differential L1-SINR reports in accordance with the configuration for differential L1-SINR reporting, a combination thereof, and/or the like. Additionally, or alternatively, the communication manager 140 may perform one or more other operations described herein.

Similarly, the base station 110 may include a communication manager 150. As described in more detail elsewhere herein, the communication manager 150 may determine a configuration for differential L1-SINR reporting, transmit an indicator of the configuration for differential L1-SINR reporting, receive one or more differential L1-SINR reports in accordance with the configuration for differential L1-SINR reporting, a combination thereof, and/or the like. Additionally, or alternatively, the communication manager 150 may perform one or more other operations described herein.

As indicated above, FIG. 1 is provided merely as an example. Other examples may differ from what is described with regard to FIG. 1.

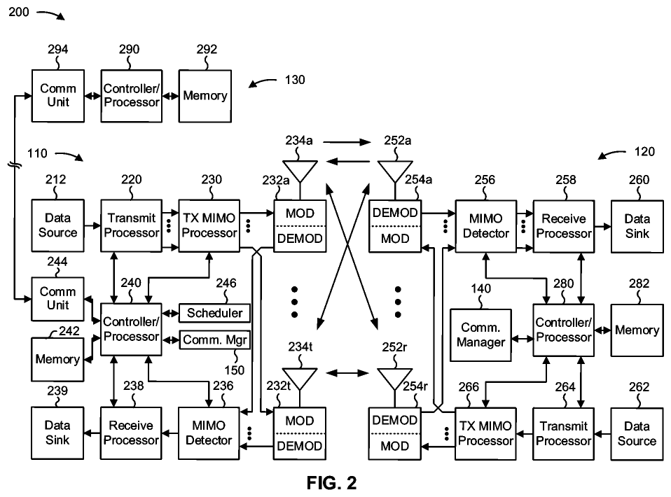

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

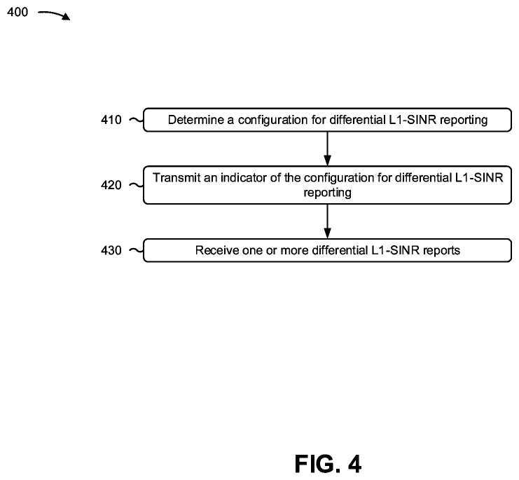

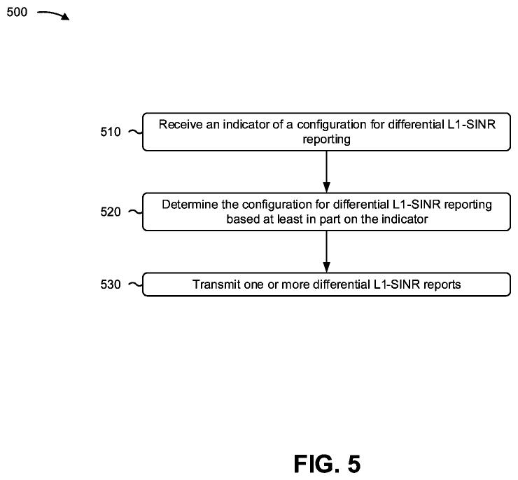

Controller/processor 240 of base station 110, controller/processor 280 of UE 120, and/or any other component(s) of FIG. 2 may perform one or more techniques associated with L1SINR reporting configuration, as described in more detail elsewhere herein. For example, controller/processor 240 of base station 110, controller/processor 280 of UE 120, and/or any other component(s) of FIG. 2 may perform or direct operations of, for example, process 400 of FIG. 4, process 500 of FIG. 5, and/or other processes as described herein. Memories 242 and 282 may store data and program codes for base station 110 and UE 120, respectively. A scheduler 246 may schedule UEs for data transmission on the downlink and/or uplink.

In some aspects, the UE 120 may include means for receiving an indicator of a configuration for differential L1-SINR reporting, means for determining the configuration for differential L1-SINR reporting based at least in part on receiving the indicator of the configuration for differential L1-SINR reporting, means for transmitting one or more differential L1-SINR reports in accordance with the configuration for differential L1-SINR reporting, a combination thereof, and/or the like. Additionally, or alternatively, the UE 120 may include means for performing one or more other operations described herein. In some aspects, such means may include the communication manager 140. Additionally, or alternatively, such means may include one or more components of the UE 120 described in connection with FIG. 2.

In some aspects, the base station 110 may include means for determining a configuration for differential L1-SINR reporting, means for transmitting an indicator of the configuration for differential L1-SINR reporting, means for receiving one or more differential L1-SINR reports in accordance with the configuration for differential L1-SINR reporting, a combination thereof, and/or the like. Additionally, or alternatively, the base station 110 may include means for performing one or more other operations described herein. In some aspects, such means may include the communication manager 150. In some aspects, such means may include one or more components of the base station 110 described in connection with FIG. 2.

As indicated above, FIG. 2 is provided merely as an example. Other examples may differ from what is described with regard to FIG. 2.

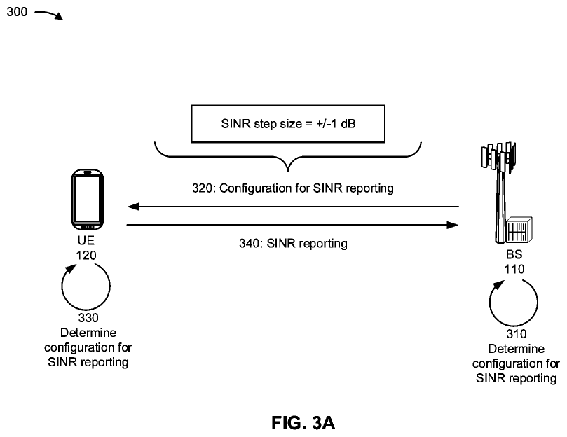

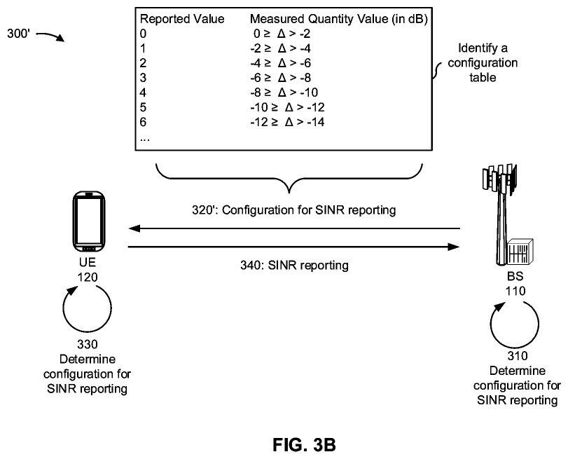

FIGS. 3A and 3B are diagrams illustrating one or more examples 300/300′ of differential L1-SINR reporting configuration, in accordance with various aspects of the present disclosure. As shown in FIGS. 3A and 3B, examples 300/300′ include a BS 110 and a UE 120.

As shown in FIG. 3A, and by reference number 310, BS 110 may determine a configuration for differential L1-SINR reporting. For example, BS 110 may determine a range of a largest measured value of an L1-SINR measurement. For example, BS 110 may determine that a range for the L1-SINR measurements is from −140 decibel-milliwatts (dBm) to −40 dBm. Additionally, or alternatively, BS 110 may determine a step size for the range of the largest measured value of an L1-SINR measurement. For example, BS 110 may determine that the step size for the range is 1 dBm. Additionally, or alternatively, BS 110 may determine a step size with which a differential L1-SINR value is computed with reference to a largest measured value of an L1-SINR measurement. For example, BS 110 may determine a step size for the value is 2 decibels (dB). Additionally, or alternatively, BS 110 may determine a quantity of bits for a quantization of a differential L1-SINR value. For example, UE 120 may determine to use 4 bits (e.g., a first bit indicator ‘0000’ may indicate a +2 dB differential L1-SINR value, a second bit indicator ‘0001’ may indicate a +4 dB differential L1-SINR value, a third bit indicator ‘0010’ may indicate a +6 dB differential L1-SINR value).

In this case, as an example with regard to the above, UE 120 may, subsequently, measure and report a largest L1-SINR of −80 dBm, which, in a range of −140 dBm to −40 dBm, can be quantized with 7 bits in step size of 1 dBm. Subsequently, to report a measurement of −76 dBm (e.g., a differential value of 4 dB) with a step size of 2 dB, UE 120 may transmit a 4 bit indicator (e.g., ‘0001’) to identify the differential value of 4 dB, from which BS 110 may calculate the 76 dBm measurement. In this way, UE 120 and BS 110 reduce the quantity of bits to report the L1-SINR from 7 bits to 4 bits. Although some aspects are described in terms of particular ranges, step sizes, and/or bit indicators, other ranges, step sizes, and/or bit indicators are possible.

In some aspects, BS 110 may select a relatively smaller step size to increase a granularity of differential L1-SINR reporting. For example, BS 110 may select a +/−0.5 dB step size to ensure a threshold level of accuracy in a differential L1-SINR measurement report. Additionally, or alternatively, BS 110 may select a relatively larger step size (e.g., a 4 dB step size) to reduce network traffic associated with differential L1-SINR reporting by reducing a quantity of bits to enumerate possible differential L1-SINR values.

In some aspects, BS 110 may determine a differential L1-SINR range for differential L1-SINR reporting. For example, BS 110 may determine that a first indicator (e.g., a value of 0 for an indicator field) is to identify a first range of differential L1-SINR values (e.g., differential L1-SINR values of +0 dB to +2 dB) and a second indicator (e.g., a value of 1 for an indicator field) is to identify a second range of differential L1-SINR values (e.g., differential L1-SINR values of less than 0 dB to −2 dB). Additionally, or alternatively, BS 110 may select a configuration table identifying a configuration for differential L1-SINR reporting. For example, BS 110 may select a configuration from multiple different candidate configuration tables. In this case, a configuration table may identify a set of indicator values and a set of corresponding differential L1-SINR ranges for changes to differential L1-SINR measurements.

In some aspects, BS 110 may transmit information identifying the multiple different candidate configuration tables. For example, BS 110 may transmit radio resource control (RRC) signaling, medium access control (MAC) control element (CE) (MAC-CE) signaling, downlink control information (DCI) signaling, a combination thereof, and/or the like to provide the multiple different candidate configuration tables to UE 120. Additionally, or alternatively, the multiple different candidate configuration tables may be defined in a specification and UE 120 may store the multiple different candidate configuration tables in accordance with the specification.

As shown in FIG. 3A, and by reference number 320, BS 110 may transmit an indicator of the configuration for differential L1-SINR reporting. For example, BS 110 may transmit an explicit indicator identifying, for example, a differential L1-SINR step size, a quantity of bits for identifying a differential L1-SINR, a combination thereof, and/or other parameters. Additionally, or alternatively, as shown in FIG. 3B, and by reference number 320′, BS 110 may transmit an indicator of a configuration table identifying a configuration for differential L1-SINR reporting. In this case, BS 110 may transmit an indicator of an index value of the configuration table, which may enable UE 120 to select the configuration table from multiple different candidate configuration tables.

In some aspects, the configuration table may be a table identifying, for example, a range of a largest measured value of an L1-SINR, a step size of the range, a step size with which the differential L1-SINR value is computed, a quantity of bits allocated to reporting the differential L1-SINR, a combination thereof, and/or the like. In some aspects, the configuration table may be a table identifying bit indicators corresponding to differential L1-SINR values. In some aspects, BS 110 may transmit the indicator of the configuration differential L1-SINR reporting using RRC signaling, MAC-CE signaling, DCI signaling, a combination thereof, and/or the like. For example, BS 110 may set a field of a MAC-CE to identify a step size, a configuration table index, a combination thereof, and/or the like.

As shown in FIG. 3A, and by reference number 330, UE 120 may determine the configuration for differential L1-SINR reporting. For example, UE 120 may receive an explicit indicator identifying, for example, a step size for differential L1-SINR reporting and UE 120 may set the step size based at least in part on the indicator. Additionally, or alternatively, UE 120 may receive an indicator of a configuration table and may select the configuration table from multiple candidate configuration tables.

As shown in FIG. 3A, and by reference number 340, UE 120 may transmit one or more differential L1-SINR reports to BS 110 in accordance with the configuration for differential L1-SINR reporting. For example, UE 120 may perform an L1-SINR measurement of a beam BS 110, determine a differential L1-SINR with respect to a largest measured L1-SINR value, determine a bit indicator identifying the differential L1-SINR, and transmit a report including the bit indicator. In some aspects, UE 120 may transmit the bit indicator using an uplink control information, a measurement reporting allocation, a combination thereof, and/or the like.

As indicated above, FIGS. 3A and 3B are provided as one or more examples. Other examples may differ from what is described with respect to FIGS. 3A and 3B.

FIG. 4 is a diagram illustrating an example process 400 performed, for example, by a BS, in accordance with various aspects of the present disclosure. Example process 400 is an example where the BS (e.g., BS 110 or apparatus 1000, among other examples) performs operations associated with differential L1-SINR reporting configuration.

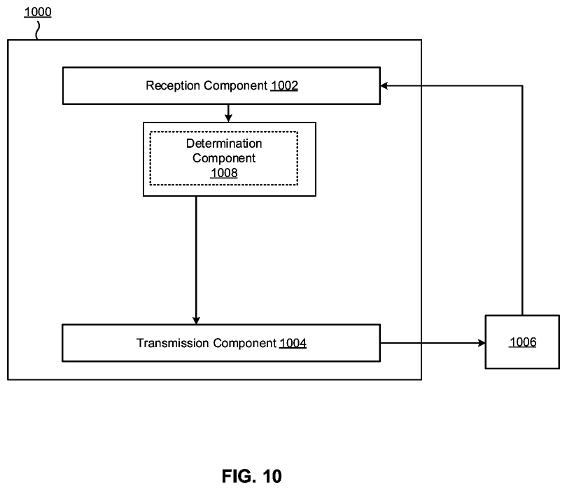

As shown in FIG. 4, in some aspects, process 400 may include determining a configuration for differential L1-SINR reporting (block 410). For example, the BS (e.g., using determination component 1008 of FIG. 10) may determine a configuration for differential L1-SINR reporting, as described above.

As further shown in FIG. 4, in some aspects, process 400 may include transmitting an indicator of the configuration for differential L1-SINR reporting (block 420). For example, the BS (e.g., using transmission component 1004 of FIG. 10) may transmit, to a UE, an indicator of the configuration for differential L1-SINR reporting, as described above.

As further shown in FIG. 4, in some aspects, process 400 may include receiving one or more differential L1-SINR reports (block 430). For example, the BS (e.g., using reception component 1002 of FIG. 10) may receive, from the UE, one or more differential L1-SINR reports in accordance with the configuration for differential L1-SINR reporting, as described above.

Process 400 may include additional aspects, such as any single aspect or any combination of aspects described below and/or in connection with one or more other processes described elsewhere herein.

In a first aspect, the configuration for differential L1-SINR reporting includes at least one of a range of a largest measured value of an L1-SINR, a step size of the range of the largest measured value, a step size with which a differential L1-SINR value is computed in reference to the largest measured value of the L1-SINR, a quantity of bits allocated to a quantization of the differential L1-SINR, or a combination thereof.

In a second aspect, alone or in combination with the first aspect, transmitting the indicator of the configuration for differential L1-SINR reporting includes transmitting information explicitly identifying the configuration for differential L1-SINR reporting.

In a third aspect, alone or in combination with one or more of the first and second aspects, transmitting the indicator of the configuration for differential L1-SINR reporting includes transmitting the indicator via at least one of a radio resource control message, a MAC-CE, a downlink control information message, or a combination thereof.

In a fourth aspect, alone or in combination with one or more of the first through third aspects, transmitting the indicator of the configuration for differential L1-SINR reporting includes transmitting information identifying a selection of a configuration table of a plurality of candidate configuration tables.

In a fifth aspect, alone or in combination with one or more of the first through fourth aspects, each configuration table, of the plurality of candidate configuration tables, includes a set of entries identifying a set of parameters for differential L1-SINR reporting.

In a sixth aspect, alone or in combination with one or more of the first through fifth aspects, the plurality of candidate configuration tables is a plurality of specification-defined candidate configuration tables.

In a seventh aspect, alone or in combination with one or more of the first through sixth aspects, process 400 includes transmitting, to the UE, a message to specify the plurality of candidate configuration tables, and transmitting the information identifying the selection of the configuration table includes transmitting the information identifying the selection of the configuration table based at least in part on transmitting the message to specify the plurality of candidate configuration tables.

In an eighth aspect, alone or in combination with one or more of the first through seventh aspects, the configuration for L1-SINR reporting is selected from a plurality of possible configurations

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a UE, in accordance with various aspects of the present disclosure. Example process 500 is an example where the UE (e.g., UE 120, apparatus 700, among other examples) performs operations associated with differential L1-SINR reporting configuration.

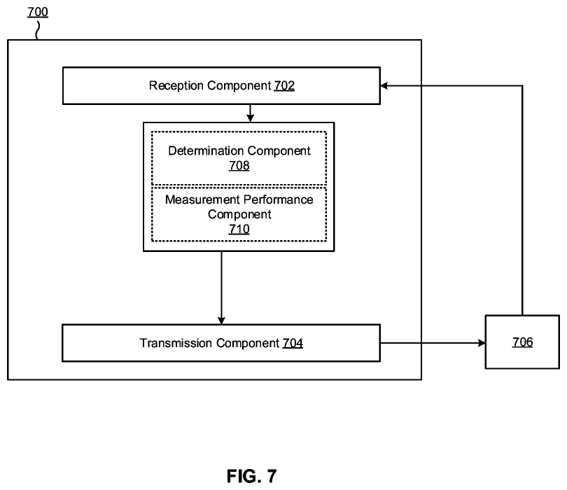

As shown in FIG. 5, in some aspects, process 500 may include receiving an indicator of a configuration for differential L1-SINR reporting (block 510). For example, the UE (e.g., using reception component 702 of FIG. 7) may receive, from a BS, an indicator of a configuration for differential L1-SINR reporting, as described above.

As further shown in FIG. 5, in some aspects, process 500 may include determining the configuration for differential L1-SINR reporting based at least in part on the indicator (block 520). For example, the UE (e.g., using determination component 708 of FIG. 7) may determine the configuration for differential L1-SINR reporting based at least in part on receiving the indicator of the configuration for differential L1-SINR reporting, as described above.

As further shown in FIG. 5, in some aspects, process 500 may include transmitting one or more differential L1-SINR reports (block 530). For example, the UE (e.g., using transmission component 704 of FIG. 7) may transmit, to the BS, one or more differential L1-SINR reports in accordance with the configuration for differential L1-SINR reporting, as described above.

Process 500 may include additional aspects, such as any single aspect or any combination of aspects described below and/or in connection with one or more other processes described elsewhere herein.

In a first aspect, process 500 includes performing one or more differential L1-SINR measurements, and transmitting the one or more differential L1-SINR reports includes transmitting the one or more differential L1-SINR reports to report on the one or more differential L1-SINR measurements.

In a second aspect, alone or in combination with the first aspect, the configuration for differential L1-SINR reporting includes at least one of: a range of a largest measured value of an L1-SINR, a step size of the range of the largest measured value, a step size with which a differential L1-SINR value is computed in reference to the largest measured value of L1-SINR, a quantity of bits allocated to a quantization of the differential L1-SINR, or a combination thereof.

In a third aspect, alone or in combination with one or more of the first and second aspects, receiving the indicator of the configuration for differential L1-SINR reporting includes receiving information explicitly identifying the configuration for differential L1-SINR reporting.

In a fourth aspect, alone or in combination with one or more of the first through third aspects, receiving the indicator of the configuration for differential L1-SINR reporting includes receiving the indicator via at least one of a radio resource control message, a MAC-CE, a downlink control information message, or a combination thereof.

In a fifth aspect, alone or in combination with one or more of the first through fourth aspects, receiving the indicator of the configuration for differential L1-SINR reporting includes receiving information identifying a selection of a configuration table of a plurality of candidate configuration tables.

In a sixth aspect, alone or in combination with one or more of the first through fifth aspects, each configuration table, of the plurality of candidate configuration tables, includes a set of entries identifying a set of parameters for differential L1-SINR reporting.

In a seventh aspect, alone or in combination with one or more of the first through sixth aspects, the plurality of candidate configuration tables is a plurality of specification defined candidate configuration tables.

In an eighth aspect, alone or in combination with one or more of the first through seventh aspects, process 500 includes receiving, from the BS, a message that specifies the plurality of candidate configuration tables, and receiving the information identifying the selection of the configuration table includes receiving the information identifying the selection of the configuration table based at least in part on receiving the message that specifies the plurality of candidate configuration tables.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a determination component 708 or a measurement performance component 710, among other examples.

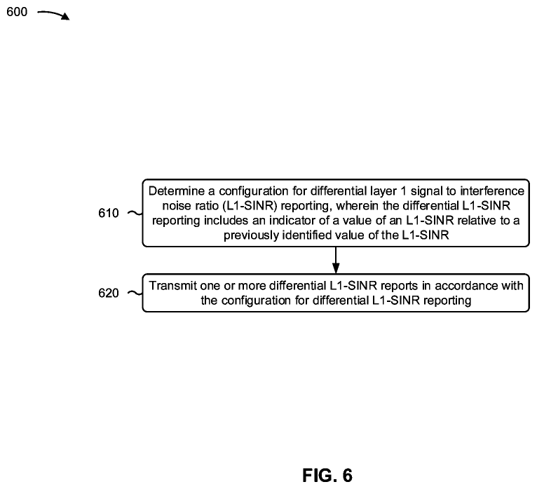

In some aspects, the apparatus 700 may be configured to perform one or more operations described herein in connection with FIGS. 3A-4. Additionally or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be collocated with the reception component 702 in a transceiver.

The determination component 708 may determine a configuration for differential layer 1 signal to interference noise ratio (L1-SINR) reporting, wherein the differential L1-SINR reporting includes an indicator of a value of an L1-SINR relative to a previously identified value of the L1-SINR. In some aspects, the determination component 708 may include a receive processor, a transmit processor, a controller/processor, a memory, or a combination thereof, of the UE described above in connection with FIG. 2. The transmission component 704 may transmit one or more differential L1-SINR reports in accordance with the configuration for differential L1-SINR reporting.

The measurement performance component 710 may perform an L1-SINR measurement to enable different L1-SINR reporting. In some aspects, the measurement performance component 710 may include one or more antennas, a demodulator, a MIMO detector, a receive processor, a controller/processor, a memory, or a combination thereof, of the UE described above in connection with FIG. 2.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

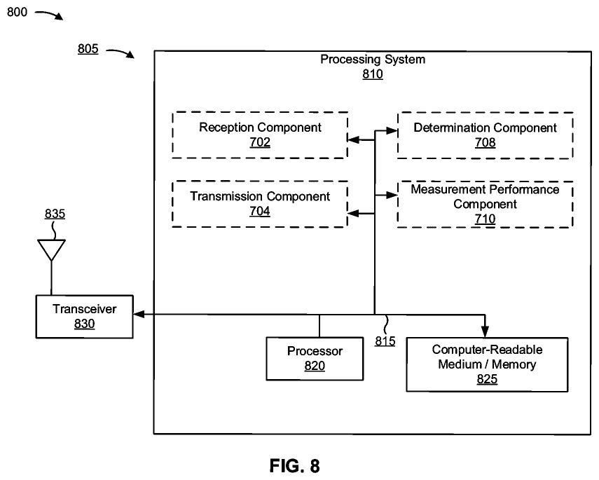

FIG. 8 is a diagram illustrating an example 800 of a hardware implementation for an apparatus 805 employing a processing system 810. The apparatus 805 may be a UE.

The processing system 810 may be implemented with a bus architecture, represented generally by the bus 815. The bus 815 may include any number of interconnecting buses and bridges depending on the specific application of the processing system 810 and the overall design constraints. The bus 815 links together various circuits including one or more processors and/or hardware components, represented by the processor 820, the illustrated components, and the computer-readable medium/memory 825. The bus 815 may also link various other circuits, such as timing sources, peripherals, voltage regulators, power management circuits, and/or the like.

The processing system 810 may be coupled to a transceiver 830. The transceiver 830 is coupled to one or more antennas 835. The transceiver 830 provides a means for communicating with various other apparatuses over a transmission medium. The transceiver 830 receives a signal from the one or more antennas 835, extracts information from the received signal, and provides the extracted information to the processing system 810, specifically the reception component 702. In addition, the transceiver 830 receives information from the processing system 810, specifically the transmission component 704, and generates a signal to be applied to the one or more antennas 835 based at least in part on the received information.

The processing system 810 includes a processor 820 coupled to a computer-readable medium/memory 825. The processor 820 is responsible for general processing, including the execution of software stored on the computer-readable medium/memory 825. The software, when executed by the processor 820, causes the processing system 810 to perform the various functions described herein for any particular apparatus. The computer-readable medium/memory 825 may also be used for storing data that is manipulated by the processor 820 when executing software. The processing system further includes at least one of the illustrated components. The components may be software modules running in the processor 820, resident/stored in the computer readable medium/memory 825, one or more hardware modules coupled to the processor 820, or some combination thereof.

In some aspects, the processing system 810 may be a component of the UE 120 and may include the memory 282 and/or at least one of the TX MIMO processor 266, the RX processor 258, and/or the controller/processor 280. In some aspects, the apparatus 805 for wireless communication includes means for determining a configuration for differential L1-SINR reporting or means for transmitting one or more differential L1-SINR reports in accordance with the configuration for differential L1-SINR reporting, among other examples. The aforementioned means may be one or more of the aforementioned components of the apparatus 700 and/or the processing system 810 of the apparatus 805 configured to perform the functions recited by the aforementioned means. As described elsewhere herein, the processing system 810 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 8 is provided as an example. Other examples may differ from what is described in connection with FIG. 8.

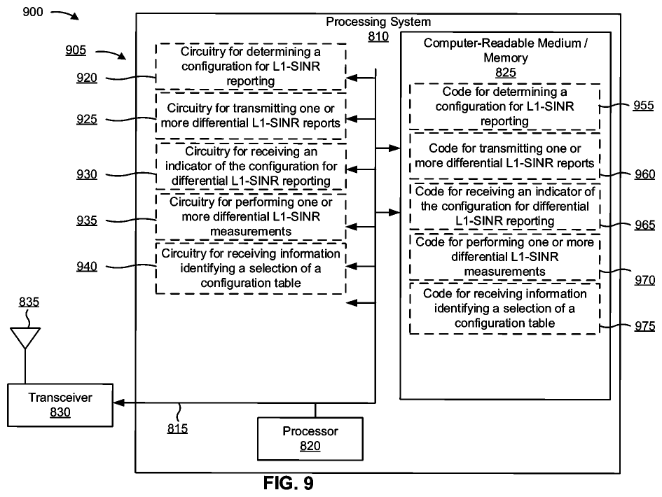

FIG. 9 is a diagram illustrating an example 900 of an implementation of code and circuitry for an apparatus 905. The apparatus 905 may be a UE, such as UE 120 among other examples.

As further shown in FIG. 9, the apparatus may include circuitry for determining a configuration for L1-SINR reporting (circuitry 920). For example, the apparatus may include circuitry to enable the apparatus to determine a configuration for L1-SINR reporting.

As further shown in FIG. 9, the apparatus may include circuitry for transmitting one or more differential L1-SINR reports (circuitry 925). For example, the apparatus may include circuitry to enable the apparatus to transmit one or more differential L1-SINR reports.

As further shown in FIG. 9, the apparatus may include circuitry for receiving an indicator of the configuration for differential L1-SINR reporting (circuitry 930). For example, the apparatus may include circuitry to enable the apparatus to receive an indicator of the configuration for differential L1-SINR reporting.

As further shown in FIG. 9, the apparatus may include circuitry for performing one or more differential L1-SINR measurements (circuitry 935). For example, the apparatus may include circuitry to enable the apparatus to perform one or more differential L1-SINR measurements.

As further shown in FIG. 9, the apparatus may include circuitry for receiving information identifying a selection of a configuration table (circuitry 940). For example, the apparatus may include circuitry to enable the apparatus to receive information identifying a selection of a configuration table.

As further shown in FIG. 9, the apparatus may include, stored in computer-readable medium 825, code for determining a configuration for L1-SINR reporting (code 955). For example, the apparatus may include code that, when executed by the processor 820, may cause the processor 820 to determine a configuration for L1-SINR reporting.

As further shown in FIG. 9, the apparatus may include, stored in computer-readable medium 825, code for transmitting one or more differential L1-SINR reports (code 960). For example, the apparatus may include code that, when executed by the processor 820, may cause the transceiver 830 to transmit one or more differential L1-SINR reports.

As further shown in FIG. 9, the apparatus may include, stored in computer-readable medium 825, code for receiving an indicator of the configuration for differential L1-SINR reporting (code 965). For example, the apparatus may include code that, when executed by the processor 820, may cause the transceiver 830 to receive an indicator of the configuration for differential L1-SINR reporting.

As further shown in FIG. 9, the apparatus may include, stored in computer-readable medium 825, code for performing one or more differential L1-SINR measurements (code 970). For example, the apparatus may include code that, when executed by the processor 820, may cause the transceiver 830 to perform one or more differential L1-SINR measurements.

As further shown in FIG. 9, the apparatus may include, stored in computer-readable medium 825, code for receiving information identifying a selection of a configuration table (code 975). For example, the apparatus may include code that, when executed by the processor 820, may cause the transceiver 830 to receive information identifying a selection of a configuration table.

FIG. 9 is provided as an example. Other examples may differ from what is described in connection with FIG. 9.

FIG. 10 is a block diagram of an example apparatus 1000 for wireless communication. The apparatus 1000 may be a BS, or a BS may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a determination component 1008 among other examples.

In some aspects, the apparatus 1000 may be configured to perform one or more operations described herein in connection with FIGS. 3A-4. Additionally or alternatively, the apparatus 1000 may be configured to perform one or more processes described herein, such as process 400 of FIG. 4 or a combination thereof. In some aspects, the apparatus 1000 and/or one or more components shown in FIG. 10 may include one or more components of the BS described above in connection with FIG. 2. Additionally, or alternatively, one or more components shown in FIG. 10 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the BS described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the BS described above in connection with FIG. 2. In some aspects, the transmission component 1004 may be collocated with the reception component 1002 in a transceiver.

The determination component 1008 may determine a configuration for differential L1-SINR reporting. In some aspects, the differential L1-SINR reporting includes an indicator of a value of an L1-SINR relative to a previously identified value of the L1-SINR. In some aspects, the determination component 1008 may include a controller/processor, a memory, or a combination thereof, of the BS described above in connection with FIG. 2. The transmission component 1004 may transmit one or more differential L1-SINR reports in accordance with the configuration for differential L1-SINR reporting. The reception component 1002 may receive, from the UE, one or more differential L1-SINR reports in accordance with the configuration for differential L1-SINR reporting.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

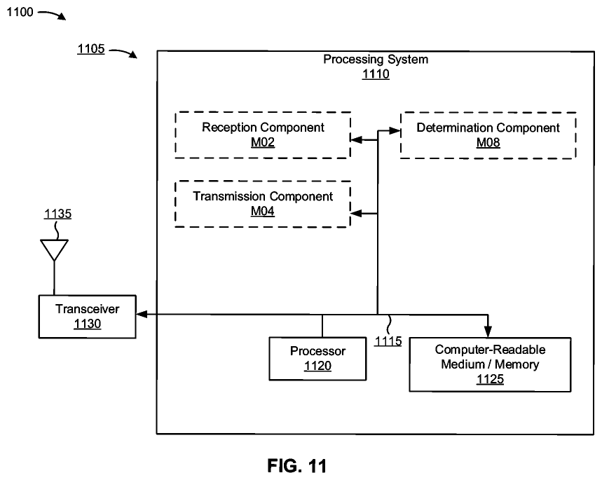

FIG. 11 is a diagram illustrating an example 1100 of a hardware implementation for an apparatus 1105 employing a processing system 1110. The apparatus 1105 may be a BS.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, power management circuits, and/or the like.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the base station 110 and may include the memory 242 and/or at least one of the TX MIMO processor 230, the RX processor 238, and/or the controller/processor 240. In some aspects, the apparatus 1105 for wireless communication includes means for determining a configuration for differential L1-SINR reporting, means for transmitting, to a UE, an indicator of the configuration for differential L1-SINR reporting, or means for receiving, from the UE, one or more differential L1-SINR reports in accordance with the configuration for differential L1-SINR reporting, among other examples.

The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 11 is provided as an example. Other examples may differ from what is described in connection with FIG. 11.

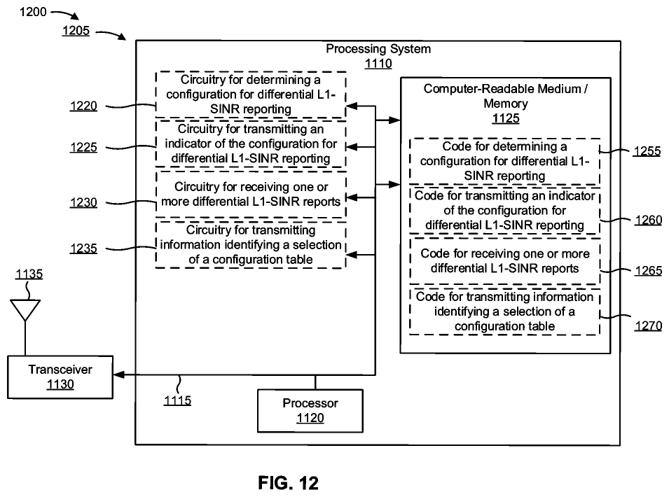

FIG. 12 is a diagram illustrating an example 1200 of an implementation of code and circuitry for an apparatus 1205. The apparatus 1205 may be a BS, such as BS 110 among other examples.

As further shown in FIG. 12, the apparatus may include circuitry for determining a configuration for differential L1-SINR reporting (circuitry 1220). For example, the apparatus may include circuitry to enable the apparatus to determine a configuration for differential L1-SINR reporting.

As further shown in FIG. 12, the apparatus may include circuitry for transmitting an indicator of the configuration for differential L1-SINR reporting (circuitry 1225). For example, the apparatus may include circuitry to enable the apparatus to transmit an indicator of the configuration for differential L1-SINR reporting.

As further shown in FIG. 12, the apparatus may include circuitry for receiving one or more differential L1-SINR reports (circuitry 1230). For example, the apparatus may include circuitry to enable the apparatus to receive one or more differential L1-SINR reports.

As further shown in FIG. 12, the apparatus may include circuitry for transmitting information identifying a selection of a configuration table (circuitry 1235). For example, the apparatus may include circuitry to enable the apparatus to transmit information identifying a selection of a configuration table.

As further shown in FIG. 12, the apparatus may include, stored in computer-readable medium 1125, code for determining a configuration for differential L1-SINR reporting (code 1255). For example, the apparatus may include code that, when executed by the processor 1120, may cause the processor 1120 to determine a configuration for differential L1-SINR reporting.

As further shown in FIG. 12, the apparatus may include, stored in computer-readable medium 1125, code for transmitting an indicator of the configuration for differential L1-SINR reporting (code 1260). For example, the apparatus may include code that, when executed by the processor 1120, may cause the processor 1120 to transmit an indicator of the configuration for differential L1-SINR reporting.

As further shown in FIG. 12, the apparatus may include, stored in computer-readable medium 1125, code for receiving one or more differential L1-SINR reports (code 1265). For example, the apparatus may include code that, when executed by the processor 1120, may cause the processor 1120 to receive one or more differential L1-SINR reports.

As further shown in FIG. 12, the apparatus may include, stored in computer-readable medium 1125, code for transmitting information identifying a selection of a configuration table (code 1270). For example, the apparatus may include code that, when executed by the processor 1120, may cause the processor 1120 to transmit information identifying a selection of a configuration table.

FIG. 12 is provided as an example. Other examples may differ from what is described in connection with FIG. 12.

FIG. 6 is a diagram illustrating an example process 600 performed, for example, by a user equipment (UE), in accordance with various aspects of the present disclosure. Example process 600 is an example where the UE (e.g., UE 120) performs operations associated with layer 1 signal to interference noise ratio reporting configuration.

As shown in FIG. 6, in some aspects, process 600 may include determining a configuration for differential layer 1 signal to interference noise ratio (L1-SINR) reporting, wherein the differential L1-SINR reporting includes an indicator of a value of an L1-SINR relative to a previously identified value of the L1-SINR (block 610). For example, the UE (e.g., using determination component 708, depicted in FIG. 7) may determine a configuration for differential layer 1 signal to interference noise ratio (L1-SINR) reporting, wherein the differential L1-SINR reporting includes an indicator of a value of an L1-SINR relative to a previously identified value of the L1-SINR, as described above.

As further shown in FIG. 6, in some aspects, process 600 may include transmitting one or more differential L1-SINR reports in accordance with the configuration for differential L1-SINR reporting (block 620). For example, the UE (e.g., using transmission component 704, depicted in FIG. 7) may transmit one or more differential L1-SINR reports in accordance with the configuration for differential L1-SINR reporting, as described above.

Process 600 may include additional aspects, such as any single aspect or any combination of aspects described below and/or in connection with one or more other processes described elsewhere herein.

In a first aspect, process 600 includes receiving an indicator of the configuration for differential L1-SINR reporting, and wherein determining the configuration comprises determining the configuration based at least in part on receiving the configuration.

In a second aspect, alone or in combination with the first aspect, process 600 includes performing one or more differential L1-SINR measurements, and wherein transmitting the one or more differential L1-SINR reports comprises transmitting the one or more differential L1-SINR reports to report on the one or more differential L1-SINR measurements.

In a third aspect, alone or in combination with one or more of the first and second aspects, the configuration for differential L1-SINR reporting includes at least one of a range of a largest measured value of an L1-SINR, a step size of the range of the largest measured value, a step size with which a differential L1-SINR value is computed in reference to the largest measured value of L1-SINR, a quantity of bits allocated to a quantization of the differential L1-SINR, or a combination thereof.

In a fourth aspect, alone or in combination with one or more of the first through third aspects, process 600 includes receiving information explicitly identifying the configuration for differential L1-SINR reporting.

In a fifth aspect, alone or in combination with one or more of the first through fourth aspects, process 600 includes receiving an indicator of the configuration via at least one of a radio resource control message, a medium access control (MAC) control element, a downlink control information message, or a combination thereof.

In a sixth aspect, alone or in combination with one or more of the first through fifth aspects, process 600 includes receiving information identifying a selection of a configuration table, of a plurality of candidate configuration tables, that includes information identifying the configuration for differential L1-SINR reporting.

In a seventh aspect, alone or in combination with one or more of the first through sixth aspects, each configuration table, of the plurality of candidate configuration tables, includes a set of entries identifying a set of parameters for differential L1-SINR reporting.

In an eighth aspect, alone or in combination with one or more of the first through seventh aspects, the plurality of candidate configuration tables is a plurality of specification defined candidate configuration tables.

In a ninth aspect, alone or in combination with one or more of the first through eighth aspects, process 600 includes receiving a message that specifies the plurality of candidate configuration tables, and wherein receiving the information identifying the selection of the configuration table comprises receiving the information identifying the selection of the configuration table based at least in part on receiving the message that specifies the plurality of candidate configuration tables.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
determining a configuration for differential layer 1 signal to interference noise ratio (L1-SINR) reporting, wherein the differential L1-SINR reporting includes an indicator of a value of an L1-SINR relative to a previously identified value of the L1-SINR; and
transmitting one or more differential L1-SINR reports in accordance with the configuration for differential L1-SINR reporting.

2. The method of claim 1, further comprising:
receiving an indicator of the configuration for differential L1-SINR reporting; and
wherein determining the configuration comprises:
determining the configuration based at least in part on receiving the configuration.

3. The method of claim 1, further comprising:
performing one or more differential L1-SINR measurements; and
wherein transmitting the one or more differential L1-SINR reports comprises:
transmitting the one or more differential L1-SINR reports to report on the one or more differential L1-SINR measurements.

4. The method of claim 1, wherein the configuration for differential L1-SINR reporting includes at least one of: a range of a largest measured value of an L1-SINR, a step size of the range of the largest measured value, a step size with which a differential L1-SINR value is computed in reference to the largest measured value of L1-SINR, a quantity of bits allocated to a quantization of the differential L1-SINR, or a combination thereof.

5. The method of claim 1, further comprising:
receiving information explicitly identifying the configuration for differential L1-SINR reporting.

6. The method of claim 1, further comprising:
receiving an indicator of the configuration via at least one of a radio resource control message, a medium access control (MAC) control element, a downlink control information message, or a combination thereof.

7. The method of claim 1, further comprising:
receiving information identifying a selection of a configuration table, of a plurality of candidate configuration tables, that includes information identifying the configuration for differential L1-SINR reporting.

8. The method of claim 7, wherein each configuration table, of the plurality of candidate configuration tables, includes a set of entries identifying a set of parameters for differential L1-SINR reporting.

9. The method of claim 7, wherein the plurality of candidate configuration tables is a plurality of specification defined candidate configuration tables.

10. The method of claim 7, further comprising:
receiving a message that specifies the plurality of candidate configuration tables; and
wherein receiving the information identifying the selection of the configuration table comprises:
receiving the information identifying the selection of the configuration table based at least in part on receiving the message that specifies the plurality of candidate configuration tables.

11. A method of wireless communication performed by a base station (BS), comprising:
determining a configuration for differential layer 1 (L1) signal to interference noise ratio (L1-SINR) reporting;
transmitting, to a user equipment (UE), an indicator of the configuration for differential L1-SINR reporting; and
receiving, from the UE, one or more differential L1-SINR reports in accordance with the configuration for differential L1-SINR reporting.

12. The method of claim 11, wherein the configuration for L1-SINR reporting is selected from a plurality of possible configurations.

13. The method of claim 11, wherein the configuration for differential L1-SINR reporting includes at least one of: a range of a largest measured value of an L1-SINR, a step size of the range of the largest measured value, a step size with which a differential L1-SINR value is computed in reference to the largest measured value of the L1-SINR, a quantity of bits allocated to a quantization of the differential L1-SINR, or a combination thereof.

14. The method of claim 11, wherein transmitting the indicator of the configuration for differential L1-SINR reporting comprises:
transmitting information explicitly identifying the configuration for differential L1-SINR reporting.

15. The method of claim 11, wherein transmitting the indicator of the configuration for differential L1-SINR reporting comprises:
transmitting the indicator via at least one of a radio resource control message, a medium access control (MAC) control element, a downlink control information message, or a combination thereof.

16. The method of claim 11, wherein transmitting the indicator of the configuration for differential L1-SINR reporting comprises:
transmitting information identifying a selection of a configuration table of a plurality of candidate configuration tables.

17. The method of claim 16, wherein each configuration table, of the plurality of candidate configuration tables, includes a set of entries identifying a set of parameters for differential L1-SINR reporting.

18. The method of claim 16, wherein the plurality of candidate configuration tables is a plurality of specification-defined candidate configuration tables.

19. The method of claim 16, further comprising:
transmitting, to the UE, a message to specify the plurality of candidate configuration tables; and
wherein transmitting the information identifying the selection of the configuration table comprises:
transmitting the information identifying the selection of the configuration table based at least in part on transmitting the message to specify the plurality of candidate configuration tables.

20. A user equipment (UE) for wireless communication, comprising:
a memory; and
one or more processors coupled to the memory, the memory and the one or more processors configured to:
determine a configuration for differential layer 1 signal to interference noise ratio (L1-SINR) reporting, wherein the differential L1-SINR reporting includes an indicator of a value of an L1-SINR relative to a previously identified value of the L1-SINR; and
transmit one or more differential L1-SINR reports in accordance with the configuration for differential L1-SINR reporting.

21. The UE of claim 20, wherein the one or more processors are further configured to:
receive an indicator of the configuration for differential L1-SINR reporting; and
wherein the one or more processors, when determining the configuration, are configured to:
determine the configuration based at least in part on receiving the configuration.

22. The UE of claim 20, wherein the one or more processors are further configured to:
perform one or more differential L1-SINR measurements; and
wherein the one or more processors, when transmitting the one or more differential L1-SINR reports, are configured to:
transmit the one or more differential L1-SINR reports to report on the one or more differential L1-SINR measurements.

23. The UE of claim 20, wherein the configuration for differential L1-SINR reporting includes at least one of: a range of a largest measured value of an L1-SINR, a step size of the range of the largest measured value, a step size with which a differential L1-SINR value is computed in reference to the largest measured value of L1-SINR, a quantity of bits allocated to a quantization of the differential L1-SINR, or a combination thereof.

24. The UE of claim 20, wherein the one or more processors are further configured to:
receive information explicitly identifying the configuration for differential L1-SINR reporting.

25. The UE of claim 20, wherein the one or more processors are further configured to:
receive an indicator of the configuration via at least one of a radio resource control message, a medium access control (MAC) control element, a downlink control information message, or a combination thereof.

26. The UE of claim 20, wherein the one or more processors are further configured to:
receive information identifying a selection of a configuration table, of a plurality of candidate configuration tables, that includes information identifying the configuration.

27. The UE of claim 26, wherein each configuration table, of the plurality of candidate configuration tables, includes a set of entries identifying a set of parameters for differential L1-SINR reporting.

28. The UE of claim 26, wherein the plurality of candidate configuration tables is a plurality of specification defined candidate configuration tables.

29. The UE of claim 26, wherein the one or more processors are further configured to:
receive a message that specifies the plurality of candidate configuration tables; and
wherein the one or more processors, when receiving the information identifying the selection of the configuration table, are configured to:
receive the information identifying the selection of the configuration table based at least in part on receiving the message that specifies the plurality of candidate configuration tables.

30. A base station (BS) for wireless communication, comprising:
a memory; and
one or more processors coupled to the memory, the memory and the one or more processors configured to:
determine a configuration for differential layer 1 (L1) signal to interference noise ratio (L1-SINR) reporting;
transmit, to a user equipment (UE), an indicator of the configuration for differential L1-SINR reporting; and
receive, from the UE, one or more differential L1-SINR reports in accordance with the configuration for differential L1-SINR reporting.
